(19) United States
(12) Patent Application Publication
(10) Pub. No.: US 2009/0273562 A1
(43) Pub. Date: Nov. 5, 2009

(54) ENHANCING COMPUTER SCREEN SECURITY USING CUSTOMIZED CONTROL OF DISPLAYED CONTENT AREA

(75) Inventors: Priya Baliga, San Jose, CA (US); Lydia Mai Do, Research Triangle Park, NC (US); Mary P. Kusko, Hopewell Junction, NY (US); Fang Lu, Billerica, MA (US)

Correspondence Address: IBM CORP. (WSM);c/o WINSTEAD SECHREST & MINICK P.C., P.O. BOX 50784, DALLAS, TX, 75201, US

(73) Assignee: International Business Machines Corporation, Armonk, NY (US)

(21) Appl. No.: 12/114,641

(22) Filed: May 2, 2008

(51) Int. Cl. G09G 5/08

(52) U.S. Cl. 345/157

(57) ABSTRACT

A method, system and computer program product for enhancing the computer screen security. The gaze of a user on a screen is tracked. The locations of the screen other than the location of the gaze of the user are distorted. Information is displayed in an area on the screen (“content area”) at the location of the user's gaze. Upon receiving input (e.g., audio, touch, key sequences) from the user to tune the content area on the screen to display information, the received input is mapped to a command for tuning the content area on the screen to display the information. The content area is then reconfigured in accordance with the user's request. By allowing the content area to be customized by the user, the security is enhanced by allowing the user to control what information is to be kept private.

### TECHNICAL FIELD

The present invention relates to computer screen security, and more particularly to enhancing computer screen security using customized control of displayed content area.

### BACKGROUND OF THE INVENTION

The use of portable devices, such as a laptop computer or a personal digital assistant, in public places (e.g., airports, airplanes, hotel lobbies, coffee houses) raises security implications regarding unauthorized viewing by individuals who may be able to view the screen. Tracking the release of sensitive information on such devices in public places can be difficult since unauthorized viewers do not get direct access to the information through a computer and thus do not leave a digital fingerprint from which they could later be identified. As a result, devices have been developed to provide security on computer screens.

Security on computer screens may be provided by scrambling the information displayed on the computer screen. In order to unscramble the information displayed on the computer screen, the user wears a set of glasses that reorganizes the scrambled image so that only the authorized user (i.e., the user wearing the set of glasses) can comprehend the image. Unauthorized users passing by the computer screen would not be able to comprehend the scrambled image. However, such computer screen security devices require expensive hardware (e.g., a set of glasses) for the user to purchase that is specific for the computer device.

Security on computer screens may also be provided through the use of what is referred to as “privacy filters.” Through the use of privacy filters, the screen appears clear only to those sitting in front of the screen. However, such computer screen security devices may not provide protection in all situations, such as where a person is standing behind the user. Further, such computer screen security devices are designed to work for a specific display device.

Hence, these computer screen security devices are application specific (i.e., designed to work for a particular display device) and are limited in protecting information from being displayed to an unauthorized user (e.g., person standing behind the user may be able to view the displayed information). Additionally, these computer screen security devices do not provide the user any control over the content area (area on the screen displaying information) being displayed. By allowing the content area to be customized by the user, the security is enhanced by allowing the user to control the display area in which information is shown, hence protecting user privacy.

### BRIEF SUMMARY OF THE INVENTION

In one embodiment of the present invention, a method for enhancing computer screen security, the method comprising tracking a location of a gaze of a user on a screen. The method further comprises distorting locations on the screen other than the location of the gaze of the user. Additionally, the method comprises displaying information in a content area at the location of the gaze of the user. Furthermore, the method comprises receiving input from the user to tune the content area to display information. Further, the method comprises reconfiguring the content area to display information in response to input received from the user.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWING

A better understanding of the present invention can be obtained when the following detailed description is considered in conjunction with the following drawings, in which:

FIG. 1 is a diagram of an exemplary personal digital assistant including multiple cameras for eye tracking purposes in accordance with an embodiment of the present invention;

FIG. 2 is a diagram of an exemplary laptop computer including a camera for eye tracking purposes in accordance with an embodiment of the present invention;

FIG. 3 is a diagram of a user's eye used in connection with explaining an eye or gaze tracking mechanism in accordance with an embodiment of the present invention;

FIG. 4 is a schematic diagram illustrating the usage of an eye or gaze tracking device in accordance with an embodiment of the present invention;

FIG. 5 illustrates an embodiment of the present invention of a hardware configuration of a mobile device for practicing the principles of the present invention;

FIG. 6 is a flowchart of a method for enhancing computer screen security in accordance with an embodiment of the present invention;

FIG. 7 is a flowchart of a method for protecting the information being displayed on the screen from a second user viewing the screen in accordance with an embodiment of the present invention; and

FIG. 8 is a flowchart of a method for authenticating the user via one or more biometric technologies in accordance with an embodiment of the present invention.

### DETAILED DESCRIPTION OF THE INVENTION

The present invention comprises a method, system and computer program product for enhancing the computer screen security. In one embodiment of the present invention, the gaze of a user on a screen is tracked. The locations of the screen other than the location of the gaze of the user are distorted. Information is displayed in an area on the screen (“content area”) at the location of the user's gaze. Upon receiving input (e.g., audio, touch, key sequences) from the user to tune the content area on the screen to display information, the received input is mapped to a command (e.g., tune content area to go from a square shape of 5″×5″ to a square shape of 3″×3″) for tuning the content area on the screen to display the information. The content area is then reconfigured in accordance with the user's request. By allowing the content area to be customized by the user, the security is enhanced by allowing the user to control what information is to be kept private.

While the following discusses the present invention in connection with a personal digital assistant and a laptop computer, the principles of the present invention may be applied to any type of mobile device as well as any desktop device that has a screen displaying information that the user desires to keep private. The principles of the present invention may be applied to such device that has a screen displaying information that the user desires to keep private. Further, embodiments covering such permutations would fall within the scope of the present invention.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

As discussed in the Background section, current computer screen security devices are application specific (i.e., designed to work for a particular display device) and are limited in protecting information from being displayed to an unauthorized user (e.g., person standing behind the user may be able to view the displayed information). Additionally, current computer screen security devices do not provide the user a fine granularity of control over the content area (area on the screen displaying information) being displayed. By allowing the content area to be customized by the user, the security is enhanced by allowing the user to control what information is to be kept private.

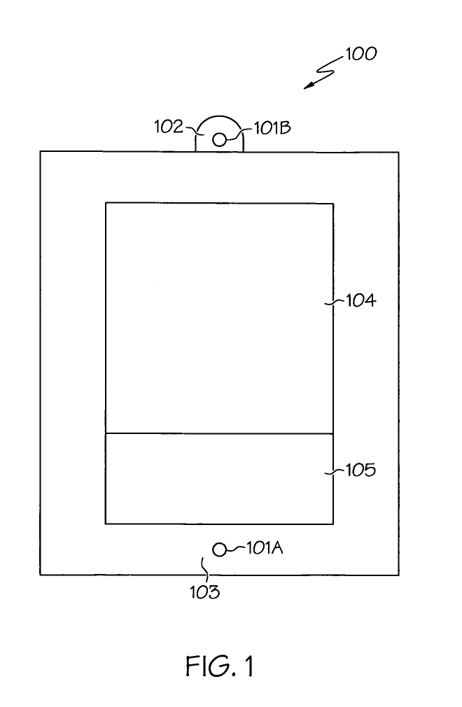

As discussed below in connection with FIGS. 1-8, the present invention provides screen security without being application specific as well as protects information from being displayed to an unauthorized user standing behind the user. Further, as discussed below in connection with FIGS. 1-8, the present invention allows the user to control the content area (area on the screen displaying information) being displayed in real-time thereby enhancing security by allowing the user to control what information is to be kept private.

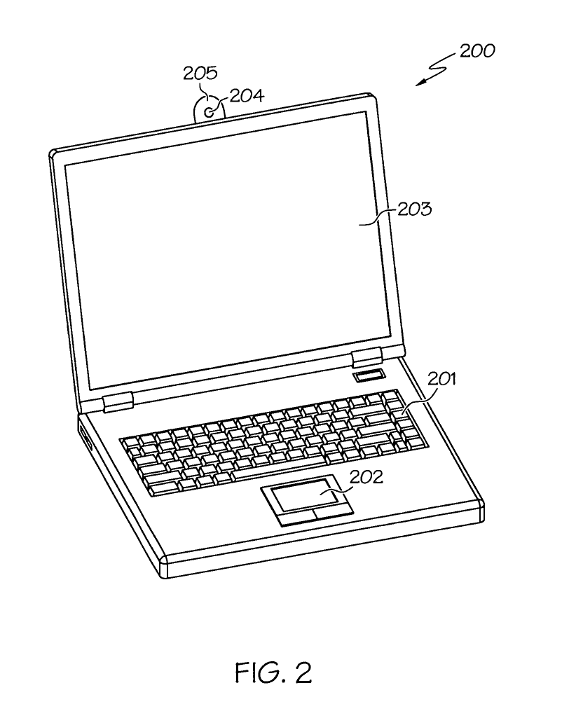

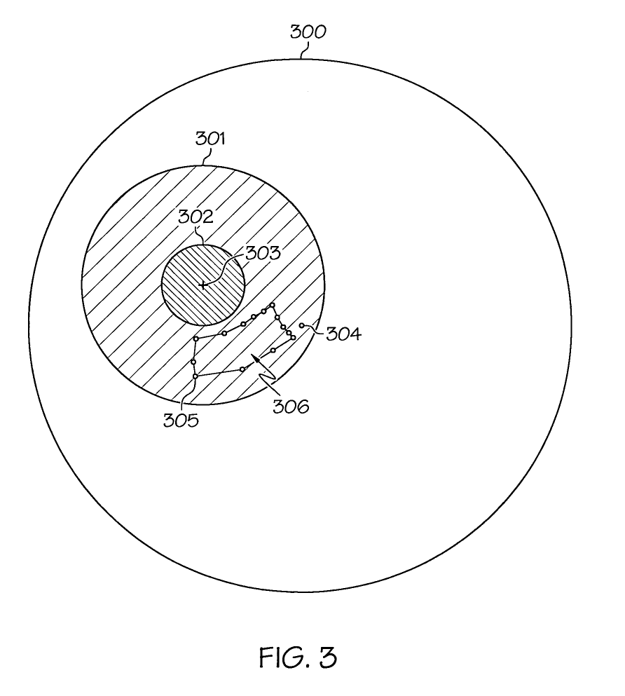

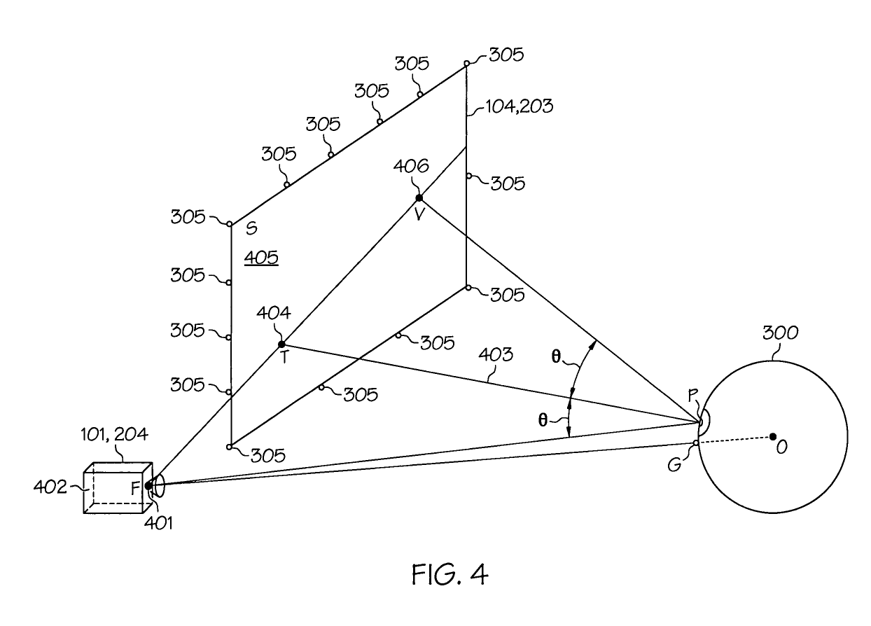

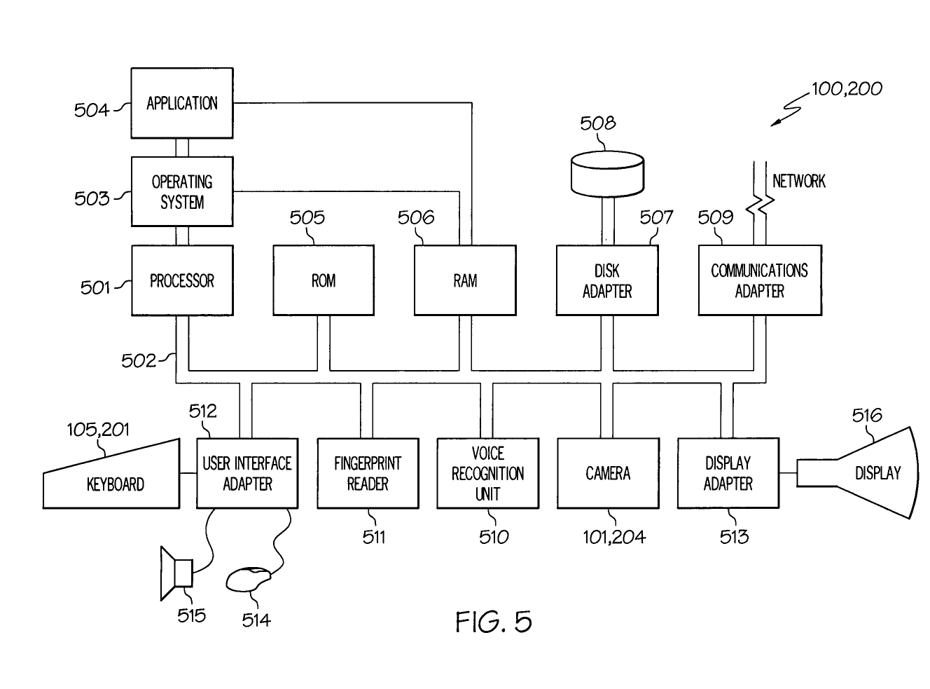

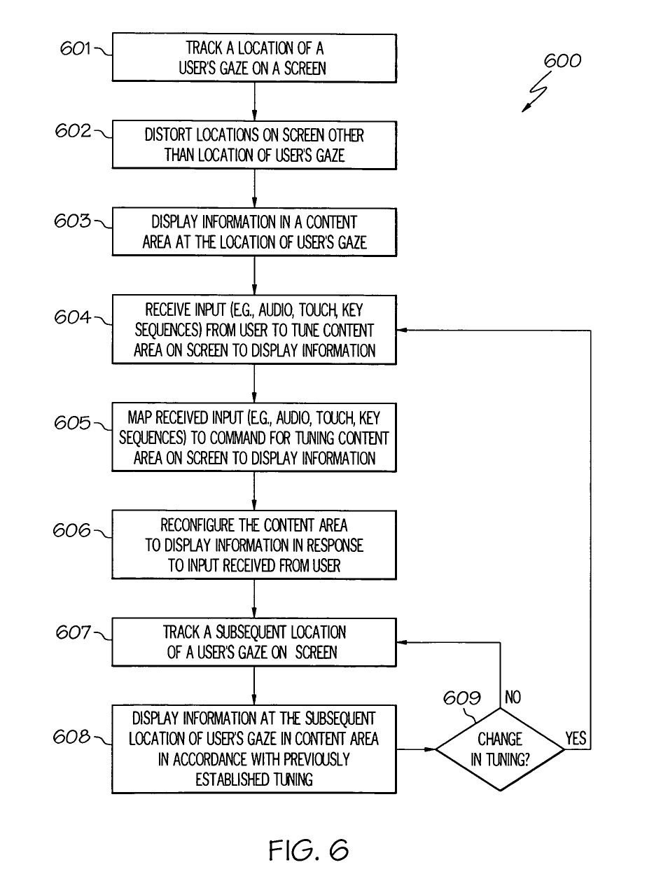

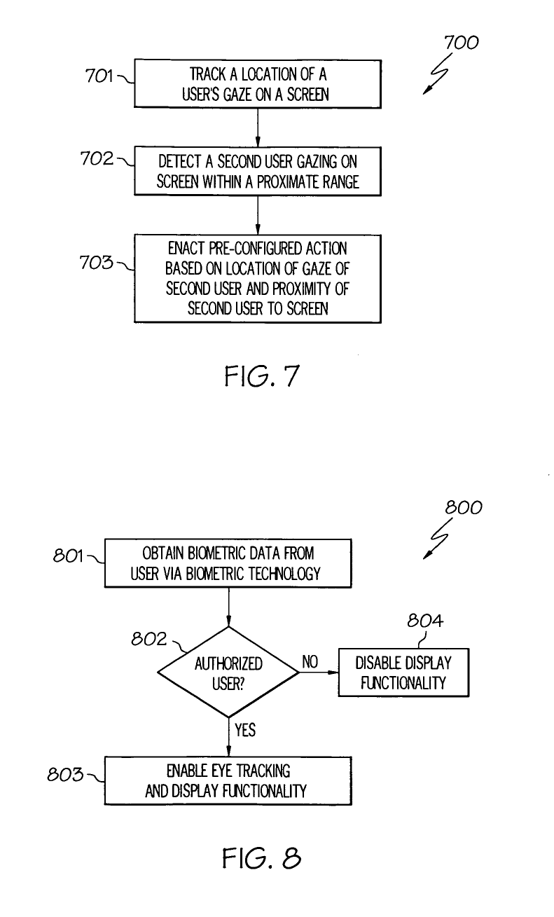

FIG. 1 is a diagram of an exemplary personal digital assistant including multiple cameras for eye tracking purposes. FIG. 2 is a diagram of an exemplary laptop computer including a camera for eye tracking purposes. FIG. 3 is a diagram of a user's eye used in connection with explaining an embodiment of an eye or gaze tracking mechanism. FIG. 4 is a schematic diagram illustrating the usage of an eye or gaze tracking device of the present invention. FIG. 5 illustrates a hardware configuration of a mobile device (e.g., laptop computer) for practicing the principles of the present invention. FIG. 6 is a flowchart of a method for enhancing computer screen security. FIG. 7 is a flowchart of a method for protecting the information being displayed on the screen from a second user viewing the screen. FIG. 8 is a flowchart of a method for authentication the user via biometric technologies.

### FIG. 1—Personal Digital Assistant for Eye Tracking Purposes

FIG. 1 illustrates an embodiment of the present invention of an exemplary mobile device, such as a personal digital assistant 100, which may include an eye or gaze tracking mechanism, as discussed further below. Personal digital assistant 100 may include one or more small cameras 101A-B that function as a gaze tracking apparatus. Cameras 101A-B may collectively or individually be referred to as cameras 101 or camera 101, respectively. In one embodiment, camera 101 may be placed in position 102. In another embodiment, camera 101 may be placed in position 103 or any other position on personal digital assistant 100 by which the gaze position of a viewer may be determined. Cameras 101 may be configured to provide the internal software (as discussed in FIG. 5) the capability of tracking multiple users' gazes upon a screen 104, which functions as the display, as discussed further below.

Referring to FIG. 1, personal digital assistant 100 may further include a keyboard 105 which functions as an input device.

The internal hardware configuration of personal digital assistant 100 will be discussed further below in connection with FIG. 5.

Another example of a mobile device, such as a laptop computer, including an eye or gaze tracking mechanism is discussed below in connection with FIG. 2.

### FIG. 2—Laptop Computer for Eye Tracking Purposes

FIG. 2 illustrates an embodiment of the present invention of an exemplary laptop computer 200 which may include an eye or gaze tracking mechanism, as discussed further below. Laptop computer 200 may include a keyboard 201 and a touchpad 202 which both function as an input device. Laptop computer 200 may further include a screen 203 which functions as the display. Laptop computer 200 may additionally include one or more cameras 204 that function as a gaze tracking apparatus. In one embodiment, camera 204 may be placed in position 205. Camera(s) 204 may be placed in any position on laptop computer 200 by which the gaze position of a viewer may be determined. Cameras 204 may be configured to provide the internal software (as discussed in FIG. 5) the capability of tracking multiple users' gazes upon screen 203 as discussed further below.

As discussed above, exemplary mobile devices, personal digital assistant 100 (FIG. 1) and laptop computer 200, include an eye or gaze tracking mechanism. There are many eye or gaze tracking techniques that may be employed in mobile devices. In one embodiment, the eye or gaze tracking mechanism of the present invention to track the eye or gaze of one or more users may implement the technique as discussed below in connection with FIGS. 3-4. FIG. 3 is a diagram of a user's eye used in connection with explaining an embodiment of an eye or gaze tracking mechanism.

### FIG. 3-Diagram of Eye

FIG. 3 illustrates a diagram of a user's eye 300 in accordance with an embodiment of the present invention. The user's eye 300 includes the eyeball or sclera, a substantially spherical cornea 301, and a pupil 302 having a pupil center 303. Note that non-spherical cornea models, including parabolic models, are known in the art and may also be employed by the present invention. At least one camera (e.g., camera 101 (FIG. 1), camera 204 (FIG. 2)) captures images of user's eye 300, particularly cornea 301. FIG. 3 is such an image. Cameras 101, 204 may track the users gaze as discussed below. Each camera 101, 204 may include a focal center, an on-axis light source illuminating the eye, and an image plane defining an image coordinate system. The light source is preferably invisible to prevent user distraction, and may for example emit radiation in the near-infrared wavelength range. The images of user's eye 300 include image aspects that will be used for determination of an eye gaze vector and determination of a point of regard, which is the intersection of the gaze vector and an observed object. These image aspects include a glint 304 due to light from the on-axis light source reflecting from eye 300 (either sclera or cornea 301) directly back to camera 101, 204. Pupil center 303 may be offset slightly due to refraction through cornea 301; the offset can be computed by the present invention, using an estimate of the index of refraction and the distance of pupil 302 behind cornea 301. The image aspects may also include a pupil image preferably created via retroreflection as is known in the art. Various image processing methods for identifying and locating the center of glint 304, pupil 302, and pupil center 303 in captured images of user's eye 300 are known in the art.

The image aspects may also include a reflected version of a set of reference points 305 forming a test pattern 306. Reference points 305 may define a reference coordinate system in real space. The relative positions of reference points 305 to each other are known, and reference points 305 may be co-planar, although that is not a limitation of the present invention. The reflection of reference points 305 is spherically distorted by reflection from cornea 301, which serves essentially as a convex spherical mirror. The reflected version of reference points 305 may also be distorted by perspective, as eye 300 is some distance from camera 101, 204 and the reflected version goes through a perspective projection to the image plane. That is, test pattern 306 will be smaller in the image plane when eye 300 is farther away from reference points 305. The reflection may also vary in appearance due to the radius of cornea curvature, and the vertical and horizontal translation of user's eye 300.

There are many possible ways of defining the set of reference points 305 or test pattern 306. Test pattern 306 may be generated by a set of point light sources deployed around a display screen (e.g., display 104 (FIG. 1), display 203 (FIG. 2) perimeter. If necessary, the light sources can be sequentially activated to enable easier identification of which light source corresponds to which image aspect. For example, a set of lights along one vertical edge of the display screen may be activated during acquisition of one image, then a set of lights along one horizontal edge of the display screen, and so forth. A variety of different lighting sequences and patterns can be used. The light sources may be built into a computer monitor during manufacture, and preferably emit infrared light. Alternately, test pattern 306 may comprise an unobtrusively interlaced design depicted in a display screen; in this case no separate light sources are needed, but camera 101, 204 is preferably synchronized to acquire an image of test pattern 306 reflection when the design is being displayed. A set of light sources on display screen 104, 203 itself may also generate test pattern 306; for example, pixels in a liquid crystal display may include an infrared-emitting device such as a light-emitting diode. It is known in the art that red liquid crystal display cells are at least partially transparent to infrared light. Another method for defining test pattern 306 is to deploy a high-contrast pre-printed pattern around display screen 104, 203 perimeter; a checkerboard pattern for example.

In yet another variation, the regularly depicted display screen content can itself serve as test pattern 306. The content may be fetched from video memory or a display adapter (not shown) to allow matching between the displayed content and image aspects. If a high frame rate camera is used, camera frames may be taken at a different frequency (e.g., twice the frequency) than the display screen refresh frequency, thus frames are captured in which the screen reflection changes over time. This allows easier separation of the screen reflection from the pupil image (e.g., by mere subtraction of consecutive frames). Generally, any distinctive pattern within the user's view can comprise test pattern 306, even if not attached to display screen 104, 203 or other object being viewed.

In the examples above, test pattern 306 may be co-planar with the surface being viewed by the user, such as display screen 104, 203, but the present invention is not constrained as such. The reference coordinate system may not necessarily coincide with a coordinate system describing the target on which a point of regard exists, such as the x-y coordinates of monitor 104, 203. As long as a mapping between the reference coordinate system and the target coordinate system exists, the present invention can compute the point of regard. Camera 101, 204 may be positioned in the plane of reference points 305, but the present invention is not limited to this embodiment, as will be described below.

The present invention mathematically maps the reference coordinate system to the image coordinate system by determining the specific spherical and perspective transformations that cause reference points 305 to appear at specific relative positions in the reflected version of test pattern 306. The present invention may update the mathematical mapping as needed to correct for changes in the position or orientation of user's eye 300, but this updating is not necessarily required during every cycle of image capture and processing. The present invention may then apply the mathematical mapping to image aspects other than reflected reference points 305, such as glint 304 and pupil center 303, as will be described below in connection with FIG. 4. FIG. 4 is a diagram of the user's eye 300 with regard to camera 101, 204 located in a screen plane according to an embodiment of the present invention

### FIG. 4—Diagram Illustrating the Usage of an Eye or Gaze Tracking Device

Referring now to FIG. 4, in connection with FIG. 3, a diagram of user's eye 300 with regard to camera 101 (FIG. 1), 204 (FIG. 2) located in a screen plane according to an embodiment of the present invention is shown. Camera 101, 204 includes a focal center 401, an image plane 402 that defines an image coordinate system, and an on-axis light source (not shown). The center of user's eye 300 is designated as point O. The reflection point of the on-axis light source from user's eye 300 is designated as point G, which is seen by camera 101, 204 as glint 304 as shown in FIG. 3. The center of the pupil is designated as point P in real space, and is seen by camera 101, 204 as pupil center 303 in image coordinates. Gaze vector 403 is the line extending from point P to the specific location (point T) on an object being directly observed by a user. Point of regard 404 is thus the intersection of gaze vector 403 with an observed object, and in this description the observed object is a display screen 104 (FIG. 1), 203 (FIG. 2). Display screen 104, 203 may be modeled as plane S, which is screen plane 405. While the observed object may be planar, the present invention is not limited to gaze tracking on planar objects, as will be described further below. Point V is the position of a virtual light source 406 that, if it actually existed at point V, its reflection from user's eye 300 would appear to coincide with pupil center 303 in image plane 402 of camera 101, 204. Or, going the other way, point V is the location of the pupil center 303 when mapped from image coordinates to screen plane coordinates. Points F, P, G, O, T, and V as shown in FIG. 4 are all co-planar. Points F, T, and V lie on a line that is co-planar with screen plane S. Angle FPT and angle VPT are equal; in other words, gaze vector 403 bisects angle FPV.

In one embodiment of the present in invention, the present invention employs at least one camera 101, 204 co-planar with screen plane 405 to capture an image of reference points as reflected from cornea 301. Specific reference points may be identified by many different means, including alternate timing of light source energization as well as matching of specific reference point distribution patterns. The present invention may then determine the specific spherical and perspective transformations required to best map the reference points in real space to the test pattern they form in image space. The present invention can for example optimize mapping variables (listed above) to minimize the difference between the observed test pattern in image coordinates and the results of transforming a known set of reference points in real space into an expected test pattern in image coordinates. Once the mathematical mapping between the image coordinate system and the reference coordinate system is defined, the present invention may apply the mapping to observed image aspects, such as backlighted pupil images and the glint due to the on-axis light source. The present invention can compute the location of point V in the coordinates of the observed object (screen plane 405) by locating pupil center 303 in image coordinates and then mathematically converting that location to coordinates within screen plane 405. Similarly, the present invention can compute the location of glint 304 in image coordinates and determine a corresponding location in the coordinates of the observed object; in the case where camera 101, 204 is co-planar with screen plane 405, the mapped glint point is simply focal center 401. Point of regard 404 on screen plane 405 may be the bisector of a line segment between point V and such a mapped glint point. Glint 304 and pupil center 303 can be connected by a line in image coordinates and then reference point images that lie near the line can be selected for interpolation and mapping into the coordinates of the observed object.

A single calibrated camera 101, 204 can determine point V and bisection of angle FPV determines gaze vector 403; if the eye-to-camera distance FP is known then the intersection of gaze vector 403 with screen plane 405 can be computed and determines point of regard 404. The eye-to-camera distance can be measured or estimated in many different ways, including the distance setting at which camera 101, 204 yields a focused image, the scale of an object in image plane 402 as seen by a lens of known focal length, or via use of an infrared rangefinder.

The present invention can also employ uncalibrated cameras 101, 204 for gaze tracking, which is a significant advantage over existing gaze tracking systems. Each uncalibrated camera 101, 204 may determine a line on screen plane 405 containing point of regard 404, and the intersection of two such lines determines point of regard 404. Mere determination of a line that contains point of regard 404 is of use in many situations.

When non-planar objects are being viewed, the intersection of the object with plane FPV is generally a curve instead of a line, and the method of computing gaze vector 403 by bisection of angle FPV will yield only approximate results. However, these results are still useful if the object being observed is not too strongly curved, or if the curvature is included in the mathematical mapping.

An alternate embodiment of the present invention employs a laser pointer to create at least one reference point. The laser pointer can be scanned to produce a test pattern on objects in real space, so that reference points need not be placed on observed objects a priori. Alternately, the laser pointer can be actively aimed, so that the laser pointer puts a spot at point V described above (i.e., a reflection of the laser spot is positioned at pupil center 303 in the image coordinate system). The laser may emit infrared or visible light.

Gaze vector 403, however determined, can control a laser pointer such that a laser spot appears at point of regard 403. As the user observes different objects and point of regard 403 changes, the laser pointer follows the motion of the point of regard so that user eye motion can be observed directly in real space.

It is noted that the principles of the present invention are not to be limited in scope to the technique discussed in FIGS. 3 and 4. Instead, the principles of the present invention are to include any technique with the capability of tracking the gaze of one or more viewers of a screen of a device. For example, the present invention may employ one or more of the following techniques to track the gaze of one or more users: (1) electro-oculography, which places skin electrodes around the eye, and records potential differences, representative of eye position; (2) corneal reflection, which directs an infrared light beam at the operator's eye and measures the angular difference between the operator's mobile pupil and the stationary light beam reflection; and (3) lumbus, pupil, and eyelid tracking, which involves scanning the eye region with an apparatus such as a camera or scanner, and analyzing the resultant image.

Furthermore, the principles of the present invention are not to be limited in scope to the use of any particular number of cameras or to a particular position of the camera(s) on the device. For example, a mobile device may include thousands of cameras embedded among liquid crystal display pixels.

An illustrative hardware configuration of a mobile device (e.g., personal digital assistant 100 (FIG. 1), laptop computer 200 (FIG. 2)) for practicing the principles of the present invention is discussed below in connection with FIG. 5.

### FIG. 5—Hardware Configuration of Mobile Device

FIG. 5 illustrates an embodiment of a hardware configuration of personal digital assistant 100 (FIG. 1), laptop computer 200 (FIG. 2) which is representative of a hardware environment for practicing the present invention. Personal digital assistant 100, laptop computer 200 may have a processor 501 coupled to various other components by system bus 502. An operating system 503 may run on processor 501 and provide control and coordinate the functions of the various components of FIG. 5. An application 504 in accordance with the principles of the present invention may run in conjunction with operating system 503 and provide calls to operating system 503 where the calls implement the various functions or services to be performed by application 504. Application 504 may include, for example, a program for enhancing computer screen security as discussed further below in association with FIG. 6. Application 504 may further include a program for protecting the information being displayed on screen 104 (FIG. 1), 203 (FIG. 2) from a second user viewing the screen as discussed further below in association with FIG. 7. Additionally, application 504 may include a program for authenticating the user via biometric technologies as discussed further below in association with FIG. 8. Furthermore, application 504 may include a program for analyzing fingerprints as discussed further below in connection with FIGS. 6 and 8.

Referring to FIG. 5, read-only memory (“ROM”) 505 may be coupled to system bus 502 and include a basic input/output system (“BIOS”) that controls certain basic functions of mobile device 100, 200. Random access memory (“RAM”) 506 and disk adapter 507 may also be coupled to system bus 502. It should be noted that software components including operating system 503 and application 504 may be loaded into RAM 506, which may be mobile device's 100, 200 main memory for execution. Disk adapter 507 may be an integrated drive electronics (“IDE”) adapter that communicates with a disk unit 508, e.g., disk drive. It is noted that the program for enhancing computer screen security, as discussed further below in association with FIG. 6, may reside in disk unit 508 or in application 504. Further, the program for protecting the information being displayed on screen 104, 203 from a second user viewing the screen, as discussed further below in association with FIG. 7, may reside in disk unit 508 or in application 504. Additionally, the program for authenticating the user via biometric technologies, as discussed further below in association with FIG. 8, may reside in disk unit 508 or in application 504. Furthermore, the program for analyzing fingerprints, as discussed further below in association with FIGS. 6 and 8, may reside in disk unit 508 or in application 504.

Referring to FIG. 5, mobile device 100, 200 may further include a communications adapter 509 coupled to bus 502. Communications adapter 509 may interconnect bus 502 with an outside network.

Mobile device 100, 200 may further include a camera 101 (FIG. 1), 204 (FIG. 2) configured to function as a gaze tracking apparatus as discussed above.

Further, mobile device 100, 200 may include a voice recognition unit 510 configured to detect the voice of an authorized user. For example, voice recognition unit 510 may be used to determine if the user at mobile device 100, 200 is authorized to enable the eye tracking and display functionality of mobile device 100, 200 as explained further below in connection with FIG. 8. In another example, voice recognition unit 510 may be used to determine voice commands from an authorized user which are used to tune the content area as discussed further below in connection with FIG. 6.

Mobile device 100, 200 may additionally include a fingerprint reader 511 configured to detect the fingerprint of an authorized user. For example, fingerprint reader 511 may be used to determine if the user at mobile device 100, 200 is authorized to enable the eye tracking and display functionality of mobile device 100, 200 as explained further below in connection with FIG. 8.

Referring to FIG. 5, input/output (“I/O”) devices may also be connected to mobile device 100, 200 via a user interface adapter 512 and a display adapter 513. Keyboard 105, 201, mouse 514 (e.g., mouse pad 202 of FIG. 2) and speaker 515 may all be interconnected to bus 502 through user interface adapter 512. Data may be inputted to mobile device 100, 200 through any of these devices. In another embodiment, data may be inputted to mobile device 100, 200 through other means, such as through the use of gestures, which mobile device 100, 200 may be configured to interpret as commands to be employed. Further, a display monitor 516 may be connected to system bus 502 by display adapter 513. In one embodiment, display monitor 516 (e.g., screen 104 of FIG. 1, screen 203 of FIG. 2) contains touch screen capability which detects a user's touch. Further, display monitor 516 may contain the capability of saving the impression made by the user and having the fingerprint impression analyzed by a program of the present invention as discussed above. In this manner, a user is capable of inputting to mobile device 100, 200 through keyboard 105, 201, mouse 514 or display 516 and receiving output from mobile device 100, 200 via display 516 or speaker 515.

The various aspects, features, embodiments or implementations of the invention described herein can be used alone or in various combinations. The methods of the present invention can be implemented by software, hardware or a combination of hardware and software. The present invention can also be embodied as computer readable code on a computer readable medium. The computer readable medium is any data storage device that can store data which can thereafter be read by a computer system. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

As discussed above, current computer screen security devices do not provide the user fine granularity of control over the content area (area on the screen displaying information) being displayed. By allowing the content area to be customized by the user, the security is enhanced by allowing the user to control what information is to be kept private. FIG. 6 is a flowchart of a method for allowing the user to control the content area (area on the screen displaying information) being displayed thereby enhancing security by allowing the user to control what information is to be kept private. A discussion of FIG. 6 is provided below.

### FIG. 6—Method for Enhancing Computer Screen Security

FIG. 6 is a flowchart of a method 600 for enhancing computer screen security in accordance with an embodiment of the present invention.

Referring to FIG. 6, in conjunction with FIGS. 1-5, in step 601, mobile device 100, 200 tracks a location of a gaze of a user on screen 104, 203. As discussed above, mobile device 100, 200 may implement any number of techniques with the capability of tracking the gaze of a viewer of a screen of a mobile device, such as via camera 101, 204.

In step 602, mobile device 100, 200 distorts the locations on screen 104, 203 other than the location of the user's gaze. For example, mobile device 100, 200 may scramble or distort the locations on screen 104, 203 other than the location of the user's gaze in such a manner as to cause those areas to be unintelligible.

In step 603, mobile device 100, 200 displays information in a content area (area on screen 104, 203 displaying information) at the location of the user's gaze.

In step 604, mobile device 100, 200 receives input (e.g., audio, touch, key sequences) from the user to tune the content area on screen 104, 203 to display information. For example, the user may say the word “Hello” which may correspond to a command to distort the entire screen. The user may say the word “Hello” when the personal space of the user has been breached. Voice recognition unit 510 of mobile device 100, 200 may be used to verify that the word is pronounced from an authorized user. For example, voice recognition unit 510 may be configured with the capability of matching the voice profile of the authorized user with the voice of the user. If there is a match, then the user is verified to be an authorized user. In one embodiment, the voice profile of the authorized user is stored in disk unit 508. Upon verifying that the word is pronounced from an authorized user, a program of the present invention may map the word received by voice recognition unit 510 to a command for tuning the content area as discussed further below in connection with step 605. Other examples for voice commands may include the authorized user saying “Well um . . . ” which may correspond to a command to decrease the current level of obscurity in the top of the screen. A common interjection of this type may be cleverly disguised as casual conversation to tune the content area. In another example of a voice command, a nervous laugh may correspond to a command for increasing the current level of obscurity for the whole screen.

As discussed above, touch may also be used by the authorized user to tune the content area. For example, any touch on the left side of display 516 (e.g., screen 104, screen 203) may correspond to a command for distorting the left half of the screen. As discussed above, display 516 may be configured with touch screen capability. Further, display monitor 516 may contain the capability of saving the impression made by the user and having the fingerprint impression analyzed by a program of the present invention to determine if the user is an authorized user.

As also discussed above, key sequences may be used by the authorized user to tune the content area. For example, the key sequence of hitting the F11 key may correspond to the command for blurring the area of screen 104, 203 displaying a music player. Thus, the content area and pixels may be mapped directly to the dimensional area of the application window.

While the above description focuses on the user using voice, touch and key sequences to input a command to tune the content area, the principles of the present invention are not to be limited to such techniques but to include any technique that allows the user to input a command in a disguised manner. Embodiments applying the principles of the present invention to such implementations would fall within the scope of the present invention.

In step 605, mobile device 100, 200 maps the received input to a command for tuning the content area on screen 104, 203 to display information. For example, a program of the present invention may map the voice term “Hello” from an authorized user to the command for distorting the full screen. In one embodiment, a data structure may include a table of voice terms, touches and key sequences along with corresponding commands. In one embodiment, such a data structure may be stored in disk unit 508 or in a memory, such as memory 505. The program of the present invention may search through the table for the corresponding voice term, touch or key sequence and identify a corresponding command, if any.

In step 606, mobile device 100, 200 reconfigures the content area to display the information in response to the input received by the user in step 604. For example, the content area may be resized from being a square shape sized 5″×5″ to a square shape sized 3″×3.″

In step 607, mobile device 100, 200 tracks a subsequent location of the user's gaze on screen 104, 203. In step 608, mobile device 100, 200 displays the information at the subsequent location of the user's gaze in the content area in accordance with the previously established tuning. For example, if the content area was resized to a square shape of 3″×3″, then when the user gazes to another area of screen 104, 203, the subsequent content area is displayed as a square shape of 3″×3″ at the new location of the user's gaze.

In step 609, mobile device 100, 200 determines whether the authorized user has changed the tuning of the content area (e.g., inputted a command to change the tuning of the content area). If the authorized user has not changed the tuning of the content area, then, mobile device 100, 200 tracks a subsequent location of the user's gaze on screen 104, 203 in step 607.

Alternatively, mobile device 100, 200 receives a subsequent input (e.g., audio, touch, key sequences) from the user to tune the content area on screen 104, 203 to display information in step 604.

Method 600 may include other and/or additional steps that, for clarity, are not depicted. Further, method 600 may be executed in a different order presented and that the order presented in the discussion of FIG. 6 is illustrative. Additionally, certain steps in method 600 may be executed in a substantially simultaneous manner or may be omitted.

While the present invention enhances screen security by allowing the user to control the content area, screen security may be further enhanced by protecting information from being displayed on screen 104, 203 when a second user is viewing screen 104, 203 within a proximate range as discussed below in connection with FIG. 7.

FIG. 7—Method for Protecting the Information being Displayed on Screen from Second User Viewing Screen

FIG. 7 is a flowchart of a method 700 for protecting the information being displayed on screen 104 (FIG. 1), 203 (FIG. 2) from a second user viewing screen 104, 203 in accordance with an embodiment of the present invention.

Referring to FIG. 7, in conjunction with FIGS. 1-5, in step 701, mobile device 100, 200 tracks a location of a gaze of a user on screen 104, 203. As discussed above, mobile device 100, 200 may implement any number of techniques with the capability of tracking the gaze of a viewer of a screen of a mobile device, such as via camera 101, 204.

In step 702, mobile device 100, 200 detects a second user gazing on screen 104, 203 within a proximate range. As discussed above, mobile device 100, 200 may implement any number of techniques with the capability of detecting a second user gazing on a screen of a mobile device, such as via camera 101, 204.

In step 703, mobile device 100, 200 enacts a pre-configured action based on the location of the gaze of the second user and the proximity of the second user to screen 104, 203. For example, an alert, such as a sound via speaker 515 or a message via display 516, may be generated by mobile device 100, 200 to alert the user that a second user is gazing at screen 104, 203 within a particular proximity to screen 104, 203. In another example, screen 104, 203 could be completely deactivated upon detecting a second user gazing at a particular location (e.g., content area) on screen 104, 203 within a particular proximity.

Method 700 may include other and/or additional steps that, for clarity, are not depicted. Further, method 700 may be executed in a different order presented and that the order presented in the discussion of FIG. 7 is illustrative. Additionally, certain steps in method 700 may be executed in a substantially simultaneous manner or may be omitted.

The present invention may further enhance screen security by authenticating the user via biometric technologies as discussed below in connection with FIG. 8.

### FIG. 8—Method for Authenticating User Via Biometric Technologies

FIG. 8 is a flowchart of a method 800 for authenticating the user via one or more biometric technologies (e.g., iris recognition, fingerprinting, voice recognition) in accordance with an embodiment of the present invention.

Referring to FIG. 8, in conjunction with FIGS. 1-5, in step 801, mobile device 100, 200 obtains biometric data from the user via one or more biometric technologies. For example, voice recognition unit 510 detects the voice of the user.

In step 802, mobile device 100, 200 determines if the voice of the user detected is an authorized user. For example, using the example of voice recognition unit 510 detecting the voice of the user, mobile device 100, 200 may compare the detected voice with a saved voice profile of an authorized user to determine if the user is authorized to enable the eye tracking and display functionality of mobile device 100, 200. If there is a match between the detected voice and the voice profile of an authorized user, then the user is an authorized user. Otherwise, the user is not an authorized user.

If the user is an authorized user, then, in step 803, mobile device 100, 200 enables the eye tracking and display functionality of mobile device 100, 200.

Alternatively, if the user is not an authorized user, then, in step 804, mobile device 100, 200 disables the display functionality of mobile device 100, 200.

While method 800 discusses the example of using voice recognition biometric technology, the principles of the present invention may be applied to any type or combination of biometric technologies. For example, method 800 may be implemented using physiological monitoring (e.g., blood pressure, heart rate, response time, etc.), iris recognition, fingerprinting, etc., and any combination of biometric technologies instead of voice recognition biometric technology.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for enhancing computer screen security, the method comprising:
tracking a location of a gaze of a user on a screen;
distorting locations on said screen other than said location of said gaze of said user;
displaying information in a content area at said location of said gaze of said user;
receiving input from said user to tune said content area to display information; and
reconfiguring said content area to display information in response to input received from said user.

2. The method as recited in claim 1 further comprising:
mapping said received input to a command for tuning said content area to display information.

3. The method as recited in claim 1 further comprising:
tracking a subsequent location of said gaze of said user; and
displaying information at said subsequent location of said gaze of said user in said content area in accordance with previously established tuning.

4. The method as recited in claim 1 further comprising:
receiving a subsequent input from said user to tune said content area to display information; and
reconfiguring said content area to display information in response to said subsequent input received from said user.

5. The method as recited in claim 1, wherein said input is received from said user via one or more of the following methods: audio, touch, key sequences and gestures.

6. The method as recited in claim 1 further comprising:
detecting a second user gazing on said screen within a proximate range; and
enacting a pre-configured action based on location of gaze on said screen of said second user and proximity of said second user to said screen.

7. The method as recited in claim 1 further comprising:
authenticating said user via one or more biometric technologies; and
enabling eye tracking and display functionality if said user is authorized.

8. A system, comprising:
a memory unit for storing a computer program for enhancing computer screen security; and
a processor coupled to said memory unit, wherein said processor, responsive to said computer program, comprises:
circuitry for tracking a location of a gaze of a user on a screen;
circuitry for distorting locations on said screen other than said location of said gaze of said user;
circuitry for displaying information in a content area at said location of said gaze of said user;
circuitry for receiving input from said user to tune said content area to display information; and
circuitry for reconfiguring said content area to display information in response to input received from said user.

9. The system as recited in claim 8, wherein said processor further comprises:
circuitry for mapping said received input to a command for tuning said content area to display information.

10. The system as recited in claim 8, wherein said processor further comprises:
circuitry for tracking a subsequent location of said gaze of said user; and
circuitry for displaying information at said subsequent location of said gaze of said user in said content area in accordance with previously established tuning.

11. The system as recited in claim 8, wherein said processor further comprises:
circuitry for receiving a subsequent input from said user to tune said content area to display information; and
circuitry for reconfiguring said content area to display information in response to said subsequent input received from said user.

12. The system as recited in claim 8, wherein said input is received from said user via one or more of the following methods: audio, touch, key sequences and gestures.

13. The system as recited in claim 8, wherein said processor further comprises:
circuitry for detecting a second user gazing on said screen within a proximate range; and
circuitry for enacting a pre-configured action based on location of gaze on said screen of said second user and proximity of said second user to said screen.

14. The system as recited in claim 8, wherein said processor further comprises:
circuitry for authenticating said user via one or more biometric technologies; and
circuitry for enabling eye tracking and display functionality if said user is authorized.

15. A computer program product embodied in a computer readable medium for enhancing computer screen security, the computer program product comprising the programming instructions for:
tracking a location of a gaze of a user on a screen;
distorting locations on said screen other than said location of said gaze of said user;
displaying information in a content area at said location of said gaze of said user;
receiving input from said user to tune said content area to display information; and
reconfiguring said content area to display information in response to input received from said user.

16. The computer program product as recited in claim 15 further comprising the programming instructions for:
mapping said received input to a command for tuning said content area to display information.

17. The computer program product as recited in claim 15 further comprising the programming instructions for:
tracking a subsequent location of said gaze of said user; and
displaying information at said subsequent location of said gaze of said user in said content area in accordance with previously established tuning.

18. The computer program product as recited in claim 15 further comprising the programming instructions for:
receiving a subsequent input from said user to tune said content area to display information; and
reconfiguring said content area to display information in response to said subsequent input received from said user.

19. The computer program product as recited in claim 15, wherein said input is received from said user via one or more of the following methods: audio, touch, key sequences and gestures.

20. The computer program product as recited in claim 15 further comprising the programming instructions for:
detecting a second user gazing on said screen within a proximate range; and
enacting a pre-configured action based on location of gaze on said screen of said second user and proximity of said second user to said screen.
